(19) United States
(12) Patent Application Publication
(10) Pub. No.: US 2026/0276298 A1
(43) Pub. Date: Sep. 17, 2026

(54) REFRIGERATOR

(71) Applicant: SAMSUNG ELECTRONICS CO., LTD., Suwon-si (KR)

(72) Inventors: Jungeun PARK, Suwon-si (KR); Junho SHIN, Suwon-si (KR); Choongeun LEE, Suwon-si (KR)

(73) Assignee: SAMSUNG ELECTRONICS CO., LTD., Suwon-si (KR)

(21) Appl. No.: 19/666,886

(22) Filed: May 4, 2026

Related U.S. Application Data
(63) Continuation of application No. PCT/KR2024/013732, filed on Sep. 10, 2024.

(30) Foreign Application Priority Data
Nov. 14, 2023 (KR) 10-2023-0157079

(51) Int. Cl. F25D 27/00; F25D 17/06; F25D 23/02

(52) U.S. Cl. CPC F25D 27/005; F25D 17/065; F25D 23/028; F25D 2317/062

(57) ABSTRACT

A refrigerator is provided. The refrigerator may include: a storage compartment; a light source disposed on a side surface of the storage compartment; and a door which has a door housing forming a door storage space spatially separated from the storage compartment and having at least a part accommodated in the storage compartment, and which opens and closes the storage compartment. The door housing may include an opening formed in a portion facing the light source so that light emitted from the light source reaches the inside of the door storage space while the door is closed.

### CROSS-REFERENCE TO RELATED APPLICATIONS

This application is a Continuation Application of International Application PCT/KR 2024/013732 filed on Sep. 10, 2024, which claims priority to Korean Patent Application No. 10-2023-0157079, filed on Nov. 14, 2023, at the Korean Ministry of Intellectual Property, the disclosures of which are incorporated herein in their entireties by reference.

### BACKGROUND

### 1.Technical Field

The present invention relates to a refrigerator.

### 2. Description of the Related Art

A refrigerator is a home appliance including a main body having a storage compartment and a cold air supply device provided to supply cold air to the storage compartment to keep food fresh.

A refrigerator includes a main body forming a storage space and a door selectively opening and closing the main body. Items are stored in the storage space, and a user may open the door to retrieve the items.

Recently, a receiving space is provided in the door itself to store items, and the items in the receiving space of the door may be retrieved by opening only a sub door or a door panel.

The information may be provided as related art for purposes of helping understand the disclosure. No claim or determination is made as to whether any of the foregoing is applicable as background art in relation to the disclosure.

### SUMMARY

One or more embodiments of the disclosure may radiate light to a space provided inside a door using a light source irradiating light to a storage compartment.

A refrigerator according to one or more embodiments may include a storage compartment, a light source disposed on a side surface of the storage compartment, and a door having a door housing forming a door storage space spatially separated from the storage compartment and configured such that at least a portion thereof is received in the storage compartment, and configured to open and close the storage compartment. The door housing may include an opening formed at a portion facing the light source such that light emitted from the light source reaches an inside of the door storage space in a state in which the door is closed.

According to one or more embodiments, the door may further include a light transmitter configured to close the opening and allow light to pass therethrough.

According to one or more embodiments, the light transmitter may include a pattern configured to induce diffuse reflection of light by refracting a direction of transmitted light.

According to one or more embodiments, the door housing may include a diffuse reflector configured to diffusely reflect light on at least a portion of an inner surface of the door housing.

According to one or more embodiments, the diffuse reflector may be formed to have a wave pattern.

According to one or more embodiments, the diffuse reflector may be formed on a surface facing toward the storage compartment among the inner surface of the door housing.

According to one or more embodiments, the opening of the door housing may extend from a side surface of the door housing along a length direction of the door housing.

According to one or more embodiments, a front surface of the door housing may be configured to be open. The door may further include a sub door configured to open and close the front surface of the door housing.

According to one or more embodiments, at least a portion of the sub door may be formed of a material through which light passes.

According to one or more embodiments, the door housing may be made of an insulation material to thermally insulate the door storage space and a storage space of the storage compartment from each other.

According to one or more embodiments, the refrigerator may further include a cold air outlet configured to discharge cold air into the door storage space of the door housing.

According to one or more embodiments, the door housing may include a cold air inlet formed at a portion facing the cold air outlet in a state in which the door is closed.

According to one or more embodiments, the light source may be configured to selectively emit light at a first illuminance and a second illuminance stronger than the first illuminance.

According to one or more embodiments, the light source may selectively emit light at the first illuminance in a state in which the door is open. The light source may be configured to selectively emit light at the second illuminance in a state in which the door is closed.

According to one or more embodiments, the light source may extend from a side surface of the storage compartment along a length direction of the refrigerator.

According to one or more embodiments proposed in the disclosure, the refrigerator may brightly illuminate an inside of a door using a light source installed in an internal housing, without separately providing a light source within the door.

Effects obtainable from exemplary embodiments of the disclosure are not limited to the above-mentioned effects, and other effects not mentioned may be clearly derived and understood by those of ordinary skill in the art to which the exemplary embodiments of the disclosure belong from the following description. In other words, unintended effects in practicing embodiments of the disclosure may also be derived by one of ordinary skill in the art from example embodiments of the disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view illustrating a refrigerator according to one or more embodiments;

FIG. 2 is a view illustrating a refrigerator illustrating a state in which a sub door is open according to one or more embodiments;

FIG. 3 is a perspective view illustrating a refrigerator in a state in which all doors are open according to one or more embodiments;

FIG. 4 is a cross-sectional view illustrating a portion of a refrigerator according to one or more embodiments;

FIG. 5 is a cross-sectional perspective view illustrating a portion of a refrigerator according to one or more embodiments;

FIG. 6 is a view illustrating a door viewed from above according to one or more embodiments;

FIG. 7 is a side view illustrating a door according to one or more embodiments;

FIG. 8 is a schematic view illustrating a light diffuse reflection structure in a door storage space of a refrigerator according to one or more embodiments;

FIG. 9 is a control block view illustrating a refrigerator according to one or more embodiments; and

FIG. 10 is a flowchart illustrating a method of controlling a light source according to whether a door of a refrigerator is open according to one or more embodiments.

In the following description, attached drawings are referred to, and specific examples that may be implemented are illustrated as examples in the drawings. Other examples may be utilized and structural changes may be made without departing from the scope of the various examples.

### DETAILED DESCRIPTION

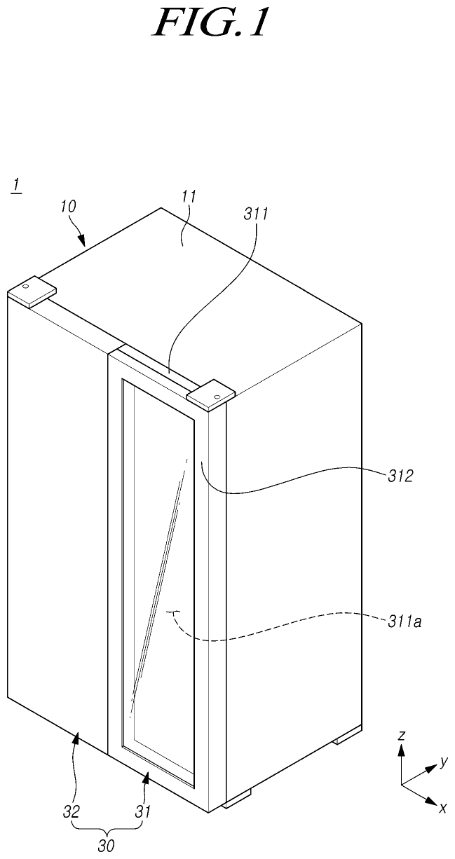

One or more embodiments of the disclosure are merely exemplified herein with reference to FIGS. 1 to 10, to describe the principle of the disclosure, and should not be interpreted as limiting the scope of the disclosure. Those skilled in the art will understand that the principle of the disclosure may be implemented in any appropriately disposed system or device.

It should be appreciated that one or more embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as A or B, at least one of A and B, at least one of A or B, A, B, or C, at least one of A, B, and C, and at least one of A, B, or C, may include all possible combinations of the items enumerated together in a corresponding one of the phrases.

The term and/or may denote a combination(s) of a plurality of related components as listed or any of the components.

Terms such as first, second, or first or second may be used simply to distinguish the corresponding component from another corresponding component, and do not limit the corresponding components in other aspects (e.g., importance or order).

As used herein, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It will be further understood that the terms comprise and/or have, as used herein, specify the presence of stated features, integers, steps, operations, elements, and/or components, but do not preclude the presence or addition of one or more other features, integers, steps, operations, elements, components, and/or groups thereof.

It will be understood that in case that a component is referred to as connected to, coupled to, supported on, or contacting another component, the components may be connected to, coupled to, supported on, or contact each other directly or via a third component.

Throughout the specification, in case that one component is positioned on another component, the first component may be positioned directly on the second component, or other component(s) may be positioned between the first and second component.

The refrigerator according to one or more embodiments may include a main body.

The main body may include an inner case, an outer case disposed outside the inner case, and an insulator provided between the inner case and the outer case.

The inner case may include at least one of a case, a plate, a panel, or a liner forming a storage compartment. The inner case may be formed as a single body or may be formed by assembling a plurality of plates. The outer case may form the outer appearance of the main body and may be coupled to an outer side of the inner case so that the insulator is disposed between the inner case and the outer case.

The insulator may insulate the inside of the storage compartment and the outside of the storage compartment so that the temperature inside the storage compartment is maintained at a set appropriate temperature without being affected by the environment outside the storage compartment. According to one or more embodiments, the insulator may include a foam insulator. The foam insulator may be formed by injecting and foaming a urethane foam formed by mixing polyurethane and a foaming agent between the inner case and the outer case.

According to one or more embodiments, the insulator may further include a vacuum insulator in addition to the foam insulator, or the insulator may be composed of only a vacuum insulator instead of the foam insulator. The vacuum insulation material may include a core material and an outer cover material that accommodates the core material and seals the inside at a pressure close to vacuum or vacuum. However, the insulator is not limited to the foam insulator or the vacuum insulator, and may include various materials that may be used for insulation.

The storage compartment may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

A refrigerator may include one or more storage compartments. In case that two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a refrigerating compartment, a freezing compartment, or an adjustable-temperature compartment divided by the use and/or temperature range thereof. The refrigerating compartment may be maintained at a temperature suitable for refrigerating and storing items, and the freezing compartment may be maintained at a temperature suitable for freezing and storing items. The term refrigerating may mean cooling the item to the extent that the item is not frozen, and for example, the refrigerating compartment may be maintained in the range of 0 degrees Celsius to 7 degrees Celsius. The term freezing may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a vegetable compartment, a fresh compartment, a cooling compartment, an ice-making compartment, and the like, in addition to the names refrigerating compartment, freezing compartment, and adjustable-temperature compartment, and the terms refrigerating compartment, freezing compartment, and adjustable-temperature compartment used below should be understood to collectively mean storage compartments having their respective corresponding uses and temperature ranges.

According to one or more embodiments, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The door may be configured to seal the storage compartment in case that the door is closed. Like the main body, the door may include an insulator to insulate the storage compartment in case that the door is closed.

According to one or more embodiments, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body in case that the door is closed. The door inner plate may include a dyke protruding rearward to mount a door basket capable of storing an object.

According to one or more embodiments, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to one or more embodiments, the refrigerator may include a cold air supply device configured to supply cold air to the storage compartment.

The cold air supply device may include a machine, an instrument, an electronic device, and/or a system combining the machine, the instrument, and the electronic device capable of generating cold air and guiding the cold air to cool the storage compartment.

According to one or more embodiments, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to one or more embodiments, the cold air supply device may include a semiconductor such as a thermoelectric element. The thermoelectric element may cool the storage compartment by heating and cooling through the Peltier effect.

According to one or more embodiments, the refrigerator may include a machine room in which at least some components belonging to the cold air supply device are arranged.

The machine room may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to one or more embodiments, the refrigerator may include a dispenser provided on the door to provide water and/or ice. The dispenser may be provided on the door to be accessed by the user without opening the door.

According to one or more embodiments, the refrigerator may include an ice maker provided to generate ice. The ice maker may include an ice-making tray storing water, an ice-separating device separating ice from the ice-making tray, and an ice bucket storing ice generated in the ice-making tray.

According to one or more embodiments, the refrigerator may include a controller for controlling the refrigerator.

The controller may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold air supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

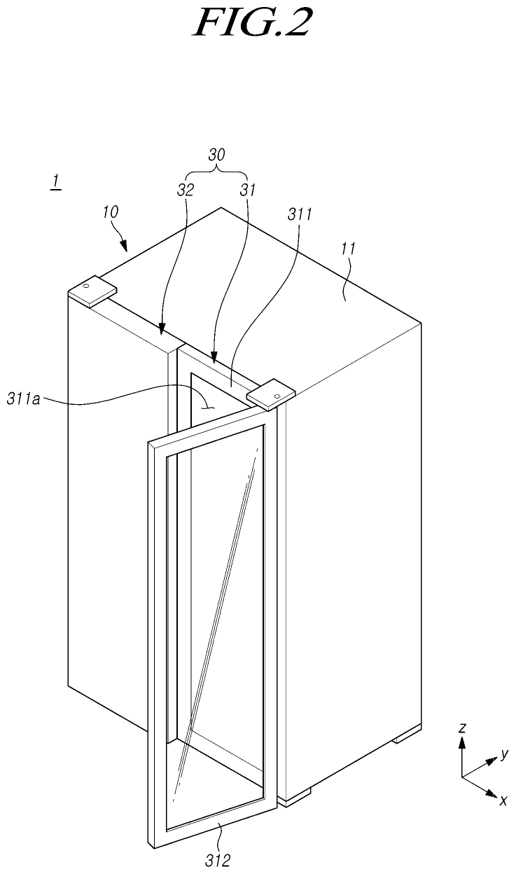

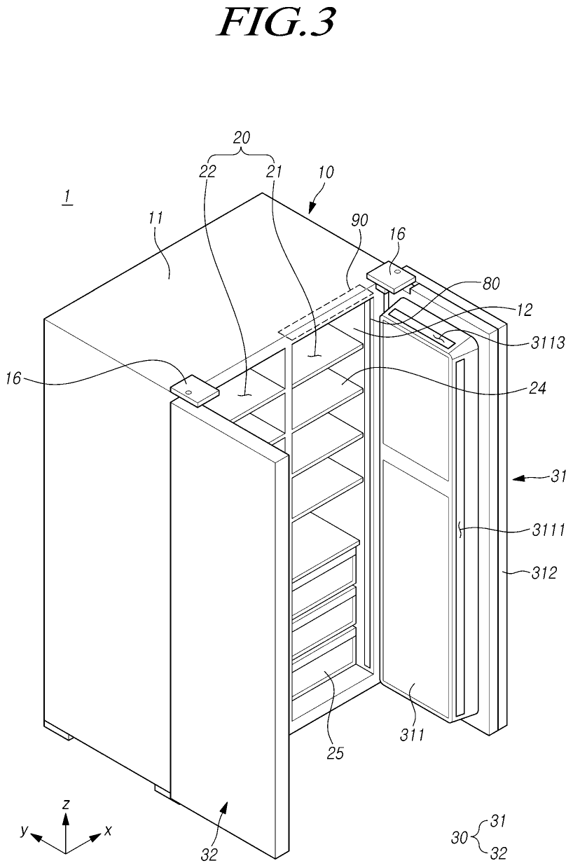

FIG. 1 is a perspective view illustrating a refrigerator according to one or more embodiments. FIG. 2 is a view illustrating a refrigerator illustrating a state in which a sub door is open according to one or more embodiments. FIG. 3 is a perspective view illustrating a refrigerator in a state in which all doors are open according to one or more embodiments.

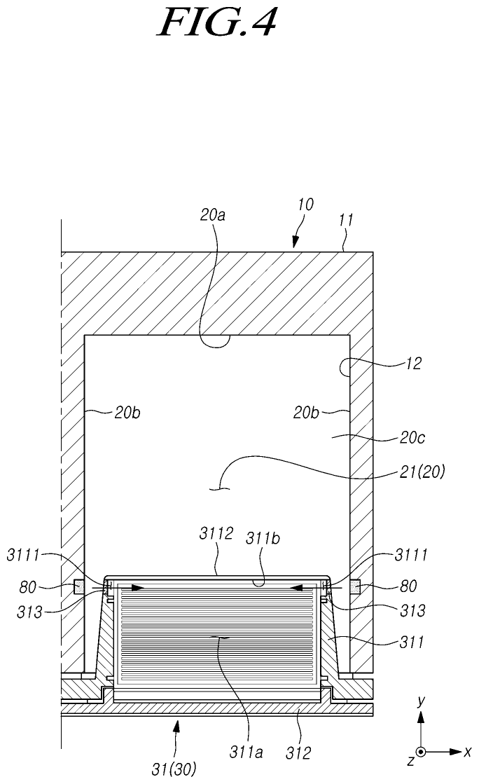

The embodiments of FIGS. 1 to 3 may be selectively combined with the embodiments of FIGS. 4 to 10.

Referring to FIGS. 1 to 3, a refrigerator 1 may include a main body 10, a storage compartment 20, a door 30, or a cold air generating unit.

The storage compartment 20 may be partitioned into several spaces inside the main body 10. The door 30 may be disposed, e.g., on the front surface of the main body 10 to open and close the storage compartment 20. The cold air generating unit may be provided inside the main body 10 to supply cold air to, e.g., the storage compartment 20.

According to one or more embodiments, the main body 10 may include an inner housing 12 or an outer housing 11. The outer housing 11 may be referred to as, e.g., an outer case. The inner housing 12 may be referred to as, e.g., an inner case. The inner housing 12 may be disposed to form an exterior of the storage compartment 20, for example. The inner housing 12 may be integrally injection-molded with, e.g., a plastic material. The outer housing 11 may be disposed to form at least a portion of an exterior of the refrigerator 1, for example. The outer housing 11 may be formed of, e.g., a metal material having excellent durability and aesthetics. A receiving space may be formed between the outer housing 11 and the inner housing 12. A main body insulator (not shown) for insulating the storage compartment 20 may be provided in a portion of the receiving space.

According to one or more embodiments, the cold air generating unit may generate cold air using a cooling circulation cycle for compressing, condensing, expanding, and evaporating the refrigerant.

According to one or more embodiments, the storage compartment 20 may be partitioned into a plurality by a partition wall. In other words, the storage compartment 20 may be formed by the inner housing 12 of the main body 10 and the partition wall. A plurality of shelves 24 or storage containers 25 may be disposed inside the storage compartment 20 to store food or the like. The plurality of shelves 24 and the storage container 25 may be disposed to be movable, e.g., removable.

The storage compartment 20 may include a first storage compartment 21 and a second storage compartment 22. Among the illustrated storage compartments 20, the first storage compartment 21 may be used as a refrigerating compartment, and the second storage compartment 22 may be used as a freezing compartment, but the disclosure is not limited thereto, and a position and a number of each of the refrigerating compartment and the freezing compartment may vary according to a need of a user.

Further, a number, a size, or a shape of the storage compartment 20 may vary according to a shape or a position of the partition wall. The freezing compartment may be maintained at about minus 20 degrees Celsius, and the refrigerating compartment may be maintained at about plus 3 degrees Celsius. The storage compartment 20 may be thermally insulated by, e.g., the partition wall.

According to one or more embodiments, the storage compartment 20 may be partitioned left and right by one vertical partition wall. Here, the vertical partition wall may be formed so that one end is in contact with the upper portion of the inner housing 12 and the other end is in contact with the lower portion of the inner housing 12. The size of the storage compartment 20 partitioned left and right may vary depending on the position of the vertical partition wall. As an example, the vertical partition wall may be provided in a center such that the storage compartments 20 partitioned left and right are provided in mirror symmetry. According to one or more embodiments, there may be a plurality of vertical partition walls. In case that there are a plurality of vertical partition walls, three or more storage compartments 20 may be provided in the left-right direction.

According to one or more embodiments, the storage compartment 20 may be partitioned up and down only by one horizontal partition wall. In other words, the storage compartment 20 may be partitioned into two, e.g., the upper storage compartment and the lower storage compartment. Here, the horizontal partition wall may be formed so that one end thereof is in contact with the left portion of the inner housing 12 and the other end thereof is in contact with the right portion of the inner housing 12. The size of the storage compartment 20 partitioned up and down may vary depending on the position of the horizontal partition wall. According to one or more embodiments, there may be a plurality of horizontal partition walls. In case that there are a plurality of horizontal partition walls, three or more storage compartments 20 may be provided in the up-down direction.

In addition to the above-described embodiments, a plurality of storage compartments 20 of various shapes may be configured according to a shape and a number of partition walls.

According to one or more embodiments, the door 30 may include a first door 31 or a second door 32 as illustrated. The door 30 may be provided to open and close, e.g., an opening of the main body 10. The first door 31 and the second door 32 may be provided in a French-door type. Further, a number and a shape of the door 30 may vary corresponding to a number and a shape of the storage compartment 20, and the door 30 may be configured in a sliding manner as well as a manner of rotating around a hinge 16.

According to one or more embodiments, the door 30 (e.g., the first door 31) may include a door housing 311 or a sub door 312. The door housing 311 and the sub door 312 may be coupled to be separable. The sub door 312 may be referred to as, e.g., a door panel.

According to an example, a front surface of the door housing 311 may be open. The front surface of the door housing 311 may be opened and closed by the sub door 312. For example, at least a portion of the door housing 311 may be of a plastic material. For example, an exterior of the door housing 311 may be injection-molded. For example, the door housing 331 may be configured with an opaque material through which light does not pass.

According to an example, at least a portion of the door housing 311 may be received in the storage compartment 20. In a state in which the first door 31 is closed, at least a portion of the door housing 311 may be received in the storage compartment 20.

The door housing 311 may have, e.g., one side fixed to the main body 10 by the hinge 16. Accordingly, the door housing 311 may be disposed to be rotatable relative to the main body 10. The door housing 311 may be disposed to be rotatable relative to the main body 10 together with, e.g., the sub door 312. The sub door 312 may form, e.g., a portion of a front exterior of the refrigerator 1. The sub door 312 may occupy an important element of aesthetics, particularly in case that the refrigerator 1 is disposed indoors.

According to an example, the door housing 311 may include a door storage space 311a. A receiving space is provided in the door housing 311 such that food items for refrigeration may be received therein. The door storage space 311a may be spatially separated from, e.g., a storage space of the storage compartment 20.

According to an example, the sub door 312 may be disposed to be rotatable relative to the door housing 311. The sub door 312 may be configured to open and close the door storage space 311a by rotating relative to the door housing 311 in a state in which the door housing 311 closes the storage space of the storage compartment 20.

According to an example, a user may access the door storage space 311a by opening only the sub door 312. The user may access the storage space of the storage compartment 20 by opening the sub door 312 and the door housing 311 together.

According to an example, the door housing 311 may include an insulation material. For example, at least a portion of the door housing 311 may be configured with an insulation material for thermally insulating the door storage space 311a and the storage space of the storage compartment 20 from each other.

According to an example, at least a portion of the sub door 312 may be configured to allow light to pass therethrough. A user may visually check food items or objects received in the door storage space 311a even in a state in which the sub door 312 is closed. As an example, the sub door 312 may be a glass panel. However, the disclosure is not limited thereto.

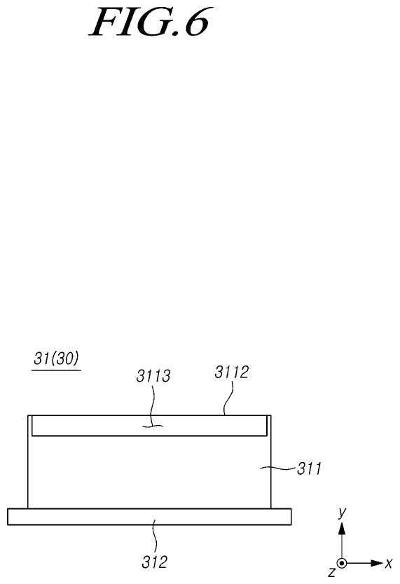

According to an example, the refrigerator 1 may include a cold air outlet 90 for supplying cold air to the door storage space 311a. The cold air outlet 90 may be positioned to face a cold air inlet of the door housing 311 (e.g., the cold air inlet 3113 of FIG. 6) to be described below. In a state in which the first door 31 is closed, the cold air outlet 90 and the cold air inlet 3113 of the door housing 311 may be positioned to face each other. The cold air outlet 90 may be located on an upper surface (e.g., +z direction surface) of the storage compartment 20, but the disclosure is not limited thereto.

According to an example, the refrigerator 1 may include a light source 80. The light source 80 may be coupled to the inner housing 12. The light source 80 may be disposed not to protrude in a direction toward the storage compartment 20 by a groove recessed in the inner housing 12.

According to an example, the light source 80 may be configured to emit light at two or more levels of illuminance. The light source 80 may be disposed to illuminate at least one of the storage space of the storage compartment 20 and the door storage space 311a. The light source 80 may illuminate, e.g., an inside of the storage compartment 20 in a state in which the first door 31 is open. The light source 80 may illuminate, e.g., the door storage space 311a in a state in which the first door 31 is closed.

According to an example, the light source 80 may selectively emit light at one of a first illuminance and a second illuminance stronger than the first illuminance. For example, the light source 80 may emit light at the first illuminance in a state in which the first door 31 is open. For example, the light source 80 may emit light at the second illuminance in a state in which the first door 31 is closed. It is necessary to emit light at a higher illuminance in order to brightly illuminate the door storage space 311a of the first door 31 with the light source 80 mounted on the inner housing 12.

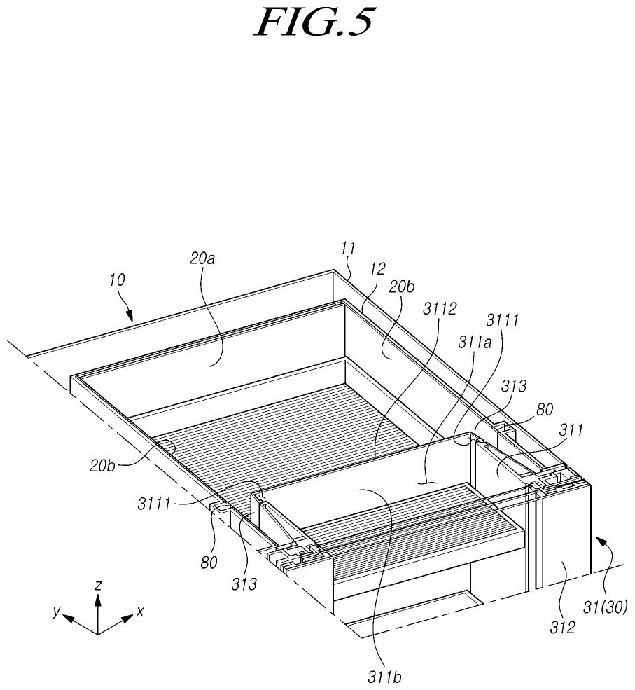

FIG. 4 is a cross-sectional view illustrating a portion of a refrigerator according to one or more embodiments. FIG. 5 is a cross-sectional perspective view illustrating a portion of a refrigerator according to one or more embodiments.

Among the configurations illustrated in FIGS. 4 and 5, the same reference numerals are used for configurations substantially identical or similar to the configurations described with reference to FIGS. 1 to 3.

The embodiments of FIGS. 4 and 5 may be selectively combined with the embodiments of FIGS. 1 to 3 and FIGS. 6 to 10.

Referring to FIGS. 4 and 5, the refrigerator 1 may include the first door 31 and the storage compartment 20.

According to an example, the first door 31 may include at least one of a door housing 311 or a sub door 312.

According to an example, the storage compartment 20 may be formed with a front thereof being open. Here, the front may refer to a −y direction. The storage compartment 20 may include a storage space defined by at least one of a rear surface 20a, two side surfaces 20b extending perpendicularly from two opposite sides of the rear surface 20a, an upper surface extending perpendicularly from an upper side of the rear surface 20a, and a lower surface 20c extending perpendicularly from a lower side of the rear surface 20a. As an example, the rear surface 20a may be a surface located in a +y direction based on the storage space of the storage compartment 20. As an example, the side surface 20b may be a surface located in a +x direction or a −x direction based on the storage space of the storage compartment 20. As an example, the upper surface may be a +z direction surface based on the storage space of the storage compartment 20. As an example, the lower surface 20c may be a −z direction surface based on the storage space of the storage compartment 20.

According to an example, the light source 80 may be disposed to extend along a length direction of the refrigerator 1 from the side surface 20b of the storage compartment 20. Here, the length direction of the refrigerator 1 may refer to a z-axis direction.

According to an example, the light source 80 may be disposed at a front (e.g., −y direction) of the refrigerator 1 among the side surface 20b of the storage compartment 20. However, the disclosure is not limited thereto, and the light source 80 may be disposed at various locations for transmitting light to the door storage space 311a of the first door 31.

According to an example, the door housing 311 may form an opening 3111 such that light generated from the light source 80 reaches an inside of the door storage space 311a in a state in which the first door 31 is closed. The opening 3111 may be formed at a portion facing the light source 80. Light from the light source 80 may reach an inside of the door storage space 311a through the opening 3111. The opening 3111 of the door housing 311 may be located at a side portion of the door housing 311. Here, the side portion of the door housing 311 may refer to a portion located in a +x direction or a −x direction.

According to an example, the first door 31 may further include a light transmitting member (e.g., a light transmitter) 313. The light transmitting member 313 may be provided to close the opening 3111 of the door housing 311. The light transmitting member 313 may have thermal insulation performance.

According to one or more embodiments, the light transmitting member 313 may be omitted. In case that the light transmitting member 313 is omitted, cold air or air may be transferred between the storage space of the storage compartment 20 and the door storage space 311a through the opening 3111 of the door housing 311.

Although not illustrated, the light transmitting member 313 may include a pattern configured to induce diffuse reflection of light by refracting a direction of transmitted light. Light passing through the light transmitting member 313 is refracted by the pattern inducing diffuse reflection, and thus the light may be guided to head toward a front side (e.g., −y direction) of the door storage space 311a.

In the case of the disclosure, the light source 80 is not provided within the first door 31, and the door storage space 311a may be illuminated using the light source 80 installed in the inner housing 12. While the light source 80 emits light, heat energy is dissipated and, in case that a light source is installed in the door housing 311, a temperature of the door storage space 311a may rise due to heat generated from the light source. In the disclosure, the door storage space 311a may be efficiently cooled using the light source 80 installed in the inner housing 12 that is external to the door housing 311.

In the case of the disclosure, at least one of the storage compartment 20 or the door storage space 311a is illuminated using one light source 80, so that a number of light sources 80 required for manufacturing the refrigerator 1 is minimized, thereby reducing manufacturing process time and production cost.

FIG. 6 is a view illustrating a door viewed from above according to one or more embodiments.

The first door 31 illustrated in FIG. 6 may be a configuration substantially identical or similar to the first door 31 illustrated in FIGS. 1 to 5. Among the configurations illustrated in FIG. 6, the same reference numerals are used for configurations substantially identical or similar to the configurations described with reference to FIGS. 1 to 5. FIG. 6 is schematically illustrated for convenience of description, and a scope of rights of the disclosure is not limited thereto.

The embodiment of FIG. 6 may be selectively combined with the embodiments of FIGS. 1 to 5 and FIGS. 7 to 10.

Referring to FIG. 6, the first door 31 may include a door housing 311. The door housing 311 may form a cold air inlet 3113 configured to be connected to the above-described cold air outlet (e.g., the cold air outlet 90 of FIG. 3). The cold air inlet 3113 may be provided at, e.g., an upper side (e.g., +z side) of the door housing 311. The door storage space 311a may be refrigerated by cold air introduced from the cold air inlet 3113. In this case, a temperature difference between the storage space of the storage compartment 20 and the door storage space 311a may occur.

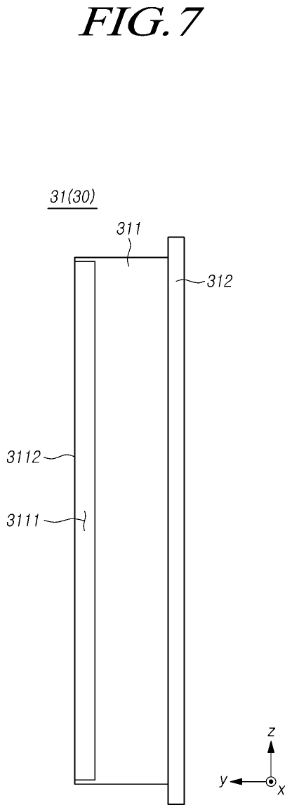

FIG. 7 is a side view illustrating a door according to one or more embodiments.

The first door 31 illustrated in FIG. 7 may be a configuration substantially identical or similar to the first door 31 illustrated in FIGS. 1 to 5. Among the configurations illustrated in FIG. 7, the same reference numerals are used for configurations substantially identical or similar to the configurations described with reference to FIGS. 1 to 5. FIG. 7 is schematically illustrated for convenience of description, and a scope of rights of the disclosure is not limited thereto.

The embodiment of FIG. 7 may be selectively combined with the embodiments of FIGS. 1 to 6 and FIGS. 8 to 10.

Referring to FIG. 7, the first door 31 may include a door housing 311. The door housing 311 may form an opening 3111 configured to face the above-described light source (e.g., the light source 80 of FIG. 3). The opening 3111 of the door housing 311 may be formed on a side surface of the door housing 311, but the disclosure is not limited thereto.

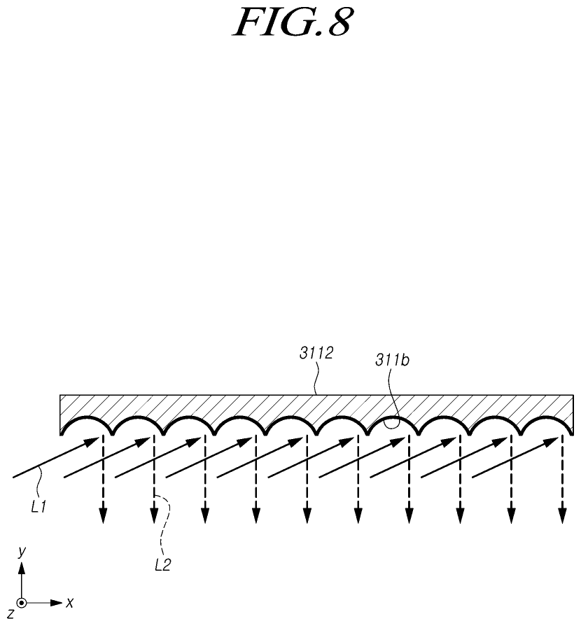

FIG. 8 is a schematic view illustrating a light diffuse reflection structure in a door storage space of a refrigerator according to one or more embodiments.

FIG. 8 is a schematic shape illustrating a diffuse reflection structure provided to adjust brightness in the door storage space 311a, and a scope of rights of the disclosure is not limited by the illustrated shape. A door housing rear surface 3112 illustrated in FIG. 8 may be included in the door housing 311 illustrated in FIGS. 1 to 7.

The embodiment of FIG. 8 may be selectively combined with the embodiments of FIGS. 1 to 7 and FIGS. 9 to 10.

According to an example, the door housing 311 may include a diffuse reflection portion (e.g., a diffuse reflector) configured to diffusely reflect light on at least a portion of an inner surface 311b. The diffuse reflection portion may be formed on, e.g., a surface facing toward the storage compartment 20 (e.g., the door housing rear surface 3112) among the inner surface 311b of the door housing 311. As an example, the diffuse reflection portion may have a regularly repeating wave pattern as illustrated, but the disclosure is not limited thereto, and the diffuse reflection portion may have a wave pattern in which an irregular wave shape is repeated. As an example, the diffuse reflection portion may be a textured surface. The shape of the diffuse reflection portion is not limited thereto, and may be represented as various angular or curved shapes for diffusely reflecting light.

Some of light radiated to the door storage space 311a may be radiated about in a direction toward the rear surface 3112 from an inside of the door housing (e.g., the door housing 311 of FIG. 4). For example, among light introduced through the opening (e.g., the opening 3111 of FIG. 4) of the door housing 311, light heading toward the door housing rear surface 3112, such as an illustrated first light L1, may be reflected by the diffuse reflection portion. The reflected light may head toward a front (e.g., −y direction) of the refrigerator 1, such as a second light L2. Brightness of the door storage space 311a may be increased by the diffuse reflection structure.

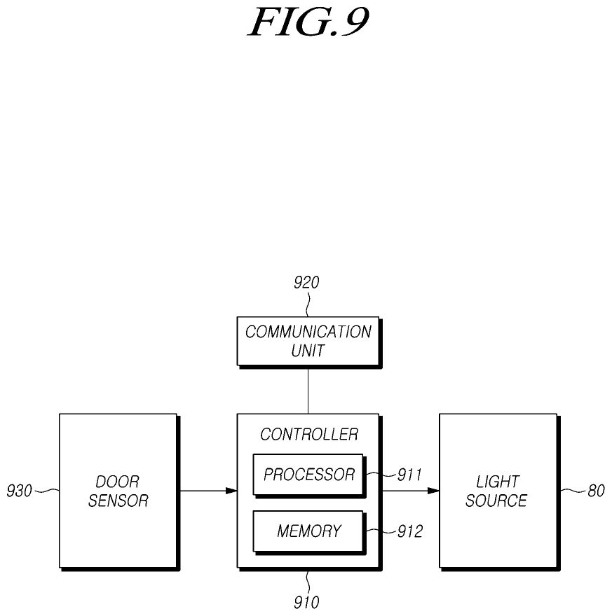

FIG. 9 is a control block view illustrating a refrigerator according to one or more embodiments.

The control block diagram illustrated in FIG. 9 is exemplary, and the disclosure is not limited to the illustrated configuration. For example, the refrigerator 1 may further include various types of sensors other than the illustrated sensors. The refrigerator 1 illustrated in FIG. 9 may be substantially identical or similar to the refrigerator 1 illustrated in FIG. 1. The same reference numerals are applied to substantially the same or similar components among the above-described components.

The embodiment of FIG. 9 may be selectively combined with the embodiments of FIGS. 1 to 7 and FIG. 10.

Referring to FIG. 9, the refrigerator 1 may include at least one of a communication unit 920, a door sensor 930, a controller 910, or a light source 80. The controller 910 may control an illuminance of the light source 80 based on a signal received from the door sensor 930.

According to an example, the refrigerator 1 may include the communication unit 920 that supports signal transmission/reception to/from the outside. In an example, the communication unit 920 may receive and/or transmit a wired/wireless signal to/from an external wired/wireless communication system, an external server, and/or other devices according to a predetermined wired/wireless communication protocol. In an example, the communication unit 920 may include one or more modules to connect the refrigerator 1 to one or more networks. In an example, the communication unit 920 may include at least one of a mobile communication module, a wired/wireless Internet module, a short-range communication module, and/or a location information module.

In an example, the mobile communication module may transmit/receive wireless signals with at least one of an external base station, an external UE, and an external server through the mobile communication network according to any communication protocol among various communication protocols for mobile communication. The wireless signals may include various types of data signals. In an example, the wireless signals may include voice call signals, video call signals, and text/multimedia message signals, but the disclosure is not limited thereto.

For example, the wired/wireless Internet module may support wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), or long term evolution-advanced (LTE-A), but is not limited thereto. In an example, the wired/wireless Internet module of the communication unit 920 may transmit/receive data according to at least one wired/wireless Internet technology among Internet technologies not listed above.

The short-range communication module may be intended for, e.g., short-range communication and may support short-range communication using at least one of Bluetooth, radio frequency identification (RFID), infrared data association (IrDA), ultra-wideband (UWB), ZigBee, near-field communication (NFC), Wi-Fi, Wi-Fi Direct, or wireless universal serial bus (USB) technology. The short-range communication module may support, e.g., wireless communication between the refrigerator 1 and a wireless communication system, between the refrigerator 1 and another device, or between the refrigerator 1 and a network in which the other device is positioned through a short-range wireless communication network.

The location information module may be, e.g., a global positioning system (GPS) module or a Wi-Fi module as a module for obtaining the location of the refrigerator 1. In case that the refrigerator 1 utilizes the GPS module, the refrigerator 1 may receive information about the location of the refrigerator 1 using the signal transmitted from the GPS satellite. In case that the refrigerator 1 utilizes the Wi-Fi module, the refrigerator 1 may receive information about the location of the refrigerator 1 based on information about a wireless access point (AP) that transmits and receives a wireless signal to and from the Wi-Fi module.

In an example, the communication unit 920 may receive the configuration data signal input by the user on the mobile terminal of the user in the form of a wireless signal according to a predetermined wireless communication protocol. In an example, the communication unit 920 may receive information and/or a command for controlling the operation of the refrigerator 1 from an external server in the form of a signal according to a predetermined wired/wireless communication protocol. The communication unit 920 may transfer various received signals to the controller 910 to be described below. In an example, the communication unit 920 may transmit various data generated or obtained on the refrigerator 1 in the form of a wired/wireless signal according to a predetermined wired/wireless communication protocol, e.g., to a mobile terminal of the user or an external server.

According to an example, the door sensor 930 may include a sensor detecting whether the door 30 is opened or closed. The door sensor 930 may include at least one of a magnetic sensor, a proximity sensor, an optical sensor, a microwave sensor, or a pressure sensor, but the disclosure is not limited thereto.

According to an example, the refrigerator 1 may include a controller 910 for controlling the overall operation of the refrigerator 1. The controller 910 may include a memory 912 for storing or recording a program and/or data for controlling each component of the refrigerator 1, and a processor 911 for generating a control signal for controlling each component of the refrigerator 1 according to the program and/or data stored in the memory 912 and information obtained from each of the other components.

According to an example, the memory 912 may store various data that may be used to control the operation of each component of the refrigerator 1. The memory 912 may store, e.g., a plurality of application programs used in the refrigerator 1, data for controlling the operation of the refrigerator 1, and instructions. At least some of the application programs stored in the memory 912 may be downloaded from an external server through wireless communication. At least some of the application programs stored in the memory 912 may be stored in the memory 912 from the time of shipment for the basic functions of the refrigerator 1.

In an example, the processor 911 of the controller 910 may receive power on/off of the refrigerator 1, operation setting information (e.g., operation start/stop, operation mode selection, operation internal temperature, etc.) of the refrigerator 1, or other various control information. For example, a processor 911 may obtain information on whether the door 30 is opened or closed from the door sensor 930.

In an example, the processor 911 of the controller 910 may generate an operation control command for each component of the refrigerator 1 based on various information received from an external source (e.g., the communication unit 920 or the door sensor 930). The processor 911 may adjust the operation of the cold air supply device to adjust the operation strength or suction strength of the refrigerator 1.

In an example, the processor 911 may continuously obtain information from an external source (e.g., the communication unit 920 or the door sensor 930) while an operation of the refrigerator 1 is in progress, and may continuously update and control an operation of each component (e.g., the light source 80) based on the obtained information.

In an example, the processor 911 may determine whether the door 30 is opened or closed using the door sensor 930. The processor 911 may set an illuminance of the light source 80 to a first illuminance in case of determining that the door 30 is open. The processor 911 may set an illuminance of the light source 80 to a second illuminance greater than the first illuminance in case of determining that the door 30 is closed. For example, the processor 911 may control the light source 80 to emit light at the second illuminance for a predetermined time from a time in case that the door 30 is closed.

In the drawings, the controller 910 is disclosed as a comprehensive component for controlling all of the components included in the refrigerator 1, but the disclosure is not limited thereto. In an example, the refrigerator 1 may be configured to include a plurality of controller components that individually control some of the components of the refrigerator 1. The refrigerator 1 may include a separate controller including a processor and a memory for controlling an operation of a user interface according to a user input. The processor 911 of the controller 910 may include a plurality of processors, and the memory 912 may include a plurality of memory devices.

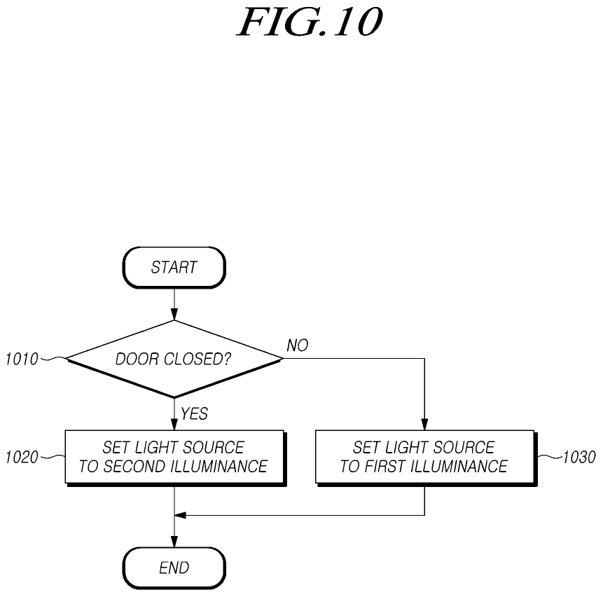

FIG. 10 is a flowchart illustrating a method of controlling a light source according to whether a door of a refrigerator is open according to one or more embodiments.

The flowchart of FIG. 10 is a flowchart illustrating a method for controlling the refrigerator 1 illustrated in FIGS. 1 to 9.

The embodiment of FIG. 10 may be selectively combined with the embodiments of FIGS. 1 to 9.

Referring to FIG. 10, the controller 910 may perform an operation 1010 of determining whether the door 30 (e.g., the first door 31) is closed. The controller 910 may determine whether the first door 31 is closed using the door sensor 930.

According to an example, in case that the controller 910 determines that the first door 31 is not closed, the controller 910 may perform an operation 1030 of setting an illuminance of the light source 80 to a first illuminance.

According to an example, in case that the controller 910 determines that the first door 31 is closed, the controller 910 may perform an operation 1020 of setting an illuminance of the light source 80 to a second illuminance. Here, the second illuminance may be greater than the first illuminance.

The terms as used herein are provided merely to describe some embodiments thereof, but are not intended to limit the disclosure. As used herein, the singular forms a, an, and the are intended to include the plural forms as well, unless the context clearly indicates otherwise. As used herein, each of such phrases as A or B, at least one of A and B, at least one of A or B, A, B, or C, at least one of A, B, and C, and at least one of A, B, or C, may include all possible combinations of the items enumerated together in a corresponding one of the phrases. As used herein, the term ‘and/or’ should be understood as encompassing any and all possible combinations by one or more of the enumerated items. As used herein, the terms include, have, and comprise are used merely to designate the presence of the feature, component, part, or a combination thereof described herein, but use of the term does not exclude the likelihood of presence or adding one or more other features, components, parts, or combinations thereof. As used herein, the terms first and second may modify various components regardless of importance and/or order and are used to distinguish a component from another without limiting the components.

As used herein, the terms configured to may be interchangeably used with the terms suitable for, having the capacity to, designed to, adapted to, made to, or capable of depending on circumstances. The term configured to does not essentially mean specifically designed in hardware to. Rather, the term configured to may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms upper side, lower side, and front and rear directions used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed:

1. A refrigerator comprising:
a storage compartment;
a light source disposed on a first side surface of the storage compartment; and
a door configured to open and close the storage compartment, the door having a door housing forming a door storage space spatially separated from the storage compartment and configured such that at least a portion thereof is received in the storage compartment,
wherein the door housing forms an opening at a portion facing the light source in a state in which the door is closed.

2. The refrigerator of claim 1, wherein the door further comprises a light transmitter configured to close the opening and allow light to pass therethrough.

3. The refrigerator of claim 2, wherein the light transmitter comprises a pattern configured to induce diffuse reflection of light by refracting a direction of transmitted light.

4. The refrigerator of claim 1, wherein the door housing includes a diffuse reflector configured to diffusely reflect light on at least a portion of an inner surface of the door housing.

5. The refrigerator of claim 4, wherein the diffuse reflector has a wave pattern.

6. The refrigerator of claim 4, wherein the diffuse reflector is formed on a surface facing toward the storage compartment among the inner surface of the door housing.

7. The refrigerator of claim 1, wherein the opening of the door housing extends from a side surface of the door housing along a length direction of the door housing.

8. The refrigerator of claim 1, wherein a front surface of the door housing is configured to be open, and
wherein the door further comprises a sub door configured to open and close the front surface of the door housing.

9. The refrigerator of claim 8, wherein at least a portion of the sub door is formed of a material through which light passes.

10. The refrigerator of claim 1, wherein at least a portion of the door housing is made of an insulation material to thermally insulate the door storage space and a storage space of the storage compartment from each other.

11. The refrigerator of claim 1, further comprising a cold air outlet configured to discharge cold air into the door storage space of the door housing.

12. The refrigerator of claim 11, wherein the door housing includes a cold air inlet formed at a portion facing the cold air outlet in a state in which the door is closed.

13. The refrigerator of claim 1, wherein the light source is configured to selectively emit light at a first illuminance and a second illuminance stronger than the first illuminance.

14. The refrigerator of claim 13, wherein the light source is configured to selectively emit light at the first illuminance in a state in which the door is open, and
wherein the light source is configured to selectively emit light at the second illuminance in a state in which the door is closed.

15. The refrigerator of claim 1, wherein the light source extends from the first side surface of the storage compartment along a length direction of the refrigerator.
